(19) United States
(12) Patent Application Publication
(10) Pub. No.: US 2012/0190127 A1
(43) Pub. Date: Jul. 26, 2012

(54) SYSTEMS AND METHODS FOR DETERMINING PROCESS CONDITIONS IN CONFINED VOLUMES

(75) Inventor: Seth Fraden, Newton, MA (US)

(73) Assignee: BRANDEIS UNIVERSITY, WALTHAM, MA (US)

(21) Appl. No.: 13/377,929

(22) PCT Filed: Jun. 8, 2010
(86) PCT No.: PCT/US10/01647

§ 371 Date: Apr. 4, 2012

Related U.S. Application Data
(60) Provisional application No. 61/186,966, filed on Jun. 15, 2009.

(51) Int. Cl. G01N 1/28; G01N 23/20

(52) U.S. Cl. 436/174; 378/71; 73/64.56

(57) ABSTRACT

Systems and methods for the determination of properties in confined (volumes are generally described. Generally, a gradient in at least one parameter (e.g., temperature) may be established across a plurality of confined volumes. In addition, at least one property (e.g., whether a crystal has been formed in the confined volume) of an interaction in at least one confined volume may be determined. In some embodiments, based upon the property determining step, a relationship between at least one parameter and at least one property may be determined. The confined volumes in which crystals may be contained may include, but are not limited to, droplets, microwells, and the like.

### RELATED APPLICATIONS

This application claims the benefit of U.S. Provisional Patent Application Ser. No. 61/186,966, filed Jun. 15, 2009, entitled “Systems and Methods for Determining Process Conditions in Confined Volumes,” by Fraden, which is incorporated herein by reference in its entirety for all purposes.

### GOVERNMENT SPONSORSHIP

This invention was sponsored by NSF Grant No. 0754769 IDBR. The government has certain rights in the invention.

### FIELD OF INVENTION

Systems and methods for the determination of process conditions for crystallization and other phase transformation processes are generally described.

### SUMMARY OF THE INVENTION

Systems and methods for the determination of process conditions for crystallization and other phase transformation processes are generally described. The subject matter of the present invention involves, in some cases, interrelated products, alternative solutions to a particular problem, and/or a plurality of different uses of one or more systems and/or articles.

In some embodiments, a method is described. The method may comprise establishing a gradient in at least one parameter across a plurality of confined volumes. The method may further comprise determining at least one property of an interaction in at least one confined volume, and, based upon the property determining step, determining a relationship between at least one parameter and at least one property.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 includes a schematic illustration of a system and method for the determination of properties in confined volumes;

FIG. 2 includes an exemplary schematic illustration outlining a system and method for the determination of crystal properties;

FIGS. 3A-3D include (A) a plot of free energy of crystal formation ΔG as a function of crystal radius r and (B-D) a magnified image of reservoirs, according to one set of embodiments;

FIGS. 4A-4B include (A) an exemplary microfluidic device, and (B) an exemplary phase diagram for protein crystallization illustrating free interface diffusion, vapor diffusion, and microbatch;

FIGS. 5A-5B include (A) an exemplary photograph of the reservoir layer of a chip and (B) a magnified image view of the second and third reservoir of a chip, according to one set of embodiments;

FIGS. 6A-6C include, according to one set of embodiments, (A) a schematic illustration of a chip that generates gradients in temperature and concentration, (B) a schematic illustrating that concentration varies horizontally and temperature varies vertically. and (C) a plot of supersaturation as a function of time for each drop;

FIGS. 7A-7D include exemplary images of droplets used to form crystals at various temperatures;

FIGS. 8A-8C include, according to some embodiments, (A) a photograph of a chip mounted on temperature gradient stage, (B) a magnified image of the chip, and (C) a further magnified image of selected drops;

FIG. 9 includes an exemplary image of an emulsion of lysozyme and salt;

FIGS. 10A-10B include (A) an exemplary image of lysozyme crystal-bearing drops in a glass capillary and (B) an exemplary diffraction pattern from the lysozyme crystal centered in (A); and

FIGS. 11A-11D include (A) an exemplary schematic of a chip that generates gradients in temperature and concentration, (B) an exemplary schematic illustrating that concentration varies horizontally and temperature varies vertically, (C) an exemplary plot of temperature as a function of time, and (D) an exemplary plot of supersaturation as a function of time.

### DETAILED DESCRIPTION

Systems and methods for the determination of properties in confined volumes are generally described. Generally, a gradient in at least one parameter (e.g., temperature) may be established across a plurality of confined volumes. In addition, at least one property (e.g., whether a crystal has been formed in the confined volume) of an interaction in at least one confined volume may be determined. In some embodiments, based upon the property determining step, a relationship between at least one parameter and at least one property may be determined. The confined volumes in which crystals may be contained may include, but are not limited to, droplets, microwells, and the like.

The systems and methods described herein may be suitable for use in a variety of fields including, for example, the pharmaceutical, nutraceutical, cosmetics, specialty chemical, pigment, and food industries, among others. Some embodiments may be particularly useful in indentifying conditions under which droplets that contain, substantially, a single crystal may be produced. Such droplets may be useful, for example, in processes for determining the crystallographic structure of crystals that would otherwise be difficult to determine, including, for example, human membrane proteins such as G protein-coupled receptors.

In some embodiments, the systems and methods described herein have the potential to identify advantageous parameters (e.g., temperature, concentration, pH, etc.) for the nucleation and growth of crystals (e.g., protein crystals), optionally using one or more parameters that can be identified by other screening methods. In some embodiments, the parameters may be chosen such that a microdrop is first supersaturated for an amount of time to nucleate a single crystal, after which the supersaturation may be reduced to a level that suppresses nucleation of additional crystals, but is still supersaturated enough for the crystal to grow slowly. The systems and methods described herein may be used to make this determination by simultaneously analyzing a plurality (e.g., tens, hundreds, thousands, etc.) of confined volumes (such as, for example, droplets). The volumes of the confined volumes may be relatively small in some instances, which may, in some cases, allow for the arrangement of a large number of confined volumes on a single, relatively small chip. In some cases, the systems and methods described herein are capable of measuring multiple parameters (e.g., temperature, pH, concentrations (e.g., of solute, proteins, other reactants, etc.), optionally as a function of time. The quantitative information may be used, for example, to enhance the ability to perform crystallization. It should be understood, however, that the embodiments described herein are not limited to crystallization. In fact, the systems and methods may be used to identify advantageous parameters for a wide variety of interactions, which include, but are not limited to precipitation of amorphous particles, chemical reactions (e.g., polymerization reactions, catalytic reactions, etc.), and the like. For example, the systems and methods described herein may be used to determine an advantageous temperature at which a catalytic reaction occurs, which may be useful, for example, in combinatorial catalysis applications.

The systems and methods described herein may exhibit one or more advantages compared to traditional processing methods. For example, in some embodiments, a large number of confined volumes may be processed simultaneously, optionally as a function of time, allowing for many tests to be performed on a single device. The systems and methods described herein can also be easily interfaced with other fluidic devices (e.g., microfluidic devices), in some cases. Additional advantages of the systems and methods associated with nanostructure growth using non-metallic catalysts are described in more detail below.

Examples of systems and methods for growing nanostructures are now provided.

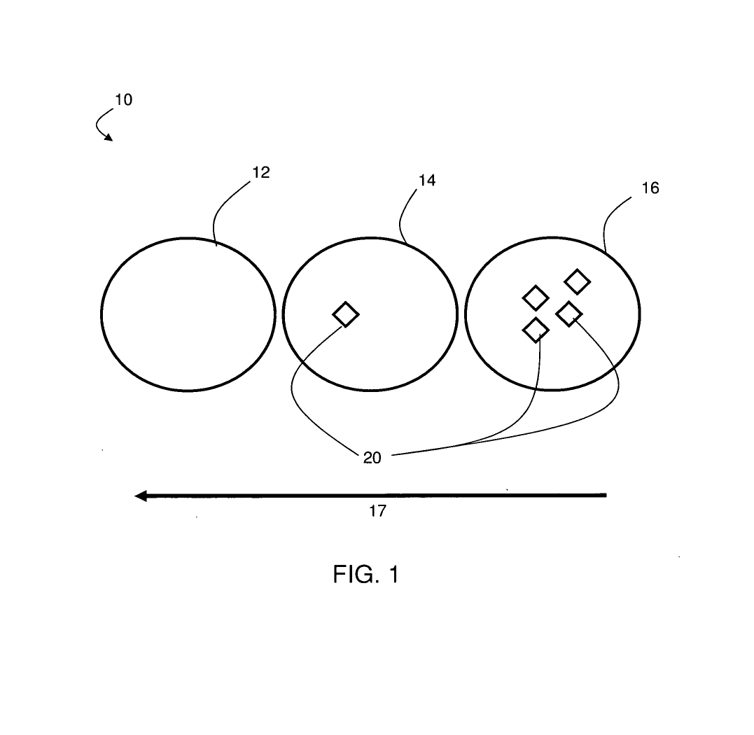

In one aspect, a method is described. The method may comprise establishing a gradient in at least one parameter (e.g., temperature) across a plurality of confined volumes (e.g., droplets), determining at least one property of an interaction in at least one confined volume, and determining a relationship between at least one parameter and at least one property based upon the property determining step. FIG. 1 includes a schematic illustration of system 10 which may be used to determine properties in confined volumes. In this exemplary embodiment, a gradient in a parameter is established across a plurality of confined volumes 12, 14, and 16. For example, a temperature gradient may be established along the direction of arrow 17, such that the temperature increases in the direction of the arrow. Thus, confined volume 12 may have a first average temperature, confined volume 14 may have a second average temperature smaller than the first average temperature, and confined volume 16 may have a third average temperature smaller than the first and second average temperatures. Gradients may be established in a variety of parameters such as, for example, temperature, pH, solvent concentration and concentration of solutes passed through a semi-permeable membrane.

In FIG. 1, the interaction comprises crystallization, which results in the formation, in some confined volumes, of crystals 20. While crystallization is shown in FIG. 1, other interactions may be determined, including, for example, precipitation of amorphous particles, chemical reactions (e.g., polymerization reactions, catalytic reactions, etc.), and the like.

In the system illustrated in FIG. 1, determining at least one property of the interaction comprises identifying confined volumes in which a single crystal has grown. In this case, confined volume 14 contains a single crystal. In the set of embodiments illustrated in FIG. 1, the relationship between the temperature and the growth of a single crystal may be recorded and used, for example, to perform further experiments in which single crystals are grown in confined volumes.

Determining at least one property may comprise, for example, determining whether a single crystal (or amorphous particle) has formed within at least one confined volume, or whether any crystals (or amorphous particles) have formed within at least one confined volume, in some cases. In some embodiments, determining at least one property may comprise determining a property of a crystal or particle (e.g., size (e.g., maximum cross-sectional diameter, etc.), crystallographic orientation, composition, etc.) within a confined volume. In some embodiments, determining at least one property may comprise determining whether a chemical reaction has proceeded in a confined volume or to what extent the chemical reaction has proceeded. In some cases, determining at least one property may comprise determining the type, composition, and/or concentration of a component (e.g., a reaction product, a crystal, a particle, etc.) in a confined volume.

Determining a relationship between at least one parameter and at least one property may comprise, for example, determining a temperature, pH, concentration, etc. that produces a desired outcome such as, for example, the production of a single crystal or particle within a confined volume, the production of a specific type, composition, or morphology of particle or crystal, the production of a desirable reaction product, or the observation of a desirable reaction rate, among others.

In some embodiments, an additional interaction (e.g., crystallization, precipitation, reaction, etc.) may be performed based at least in part upon the relationship between at least one parameter and at least one reaction property. For example, the temperature, pH, concentration, etc. recorded from a first interaction may be used in subsequent interactions to produce any of the desired effects described herein. In some embodiments, the confined volume may comprise a droplet. The term “droplet,” as used herein, refers to an isolated portion of a first fluid that is surrounded by a second fluid, where the first and second fluids are immiscible on the time scale of use of the device of the invention. As used herein, the term “fluid” generally refers to a substance that tends to flow and to conform to the outline of its container. Typically, fluids are materials that are unable to withstand a static shear stress, and when a shear stress is applied, the fluid experiences a continuing and permanent distortion. The fluid may have any suitable viscosity that permits at least some flow of the fluid. Non-limiting examples of fluids include liquids and gases, but may also include free-flowing solid particles (e.g., cells, vesicles, etc.), viscoelastic fluids, and the like. Making and using such droplets, including use in a variety of chemical, biological or biochemical settings, are described in various documents including U.S. patent application Ser. No. 11/643,151, filed Dec. 20, 2006, entitled “Compartmentalised combinatorial chemistry by microfluidic control,” published as U.S. Patent Application Publication No. 2007/0184489 on Aug. 9, 2007; International Patent Application No. PCT/US2006/007772, filed Mar. 3, 2006, entitled “Method and Apparatus for Forming Multiple Emulsions,” published as WO 2006/096571 on Sep. 14, 2006; and U.S. patent application Ser. No. 11/221,585, filed Sep. 8, 2005, entitled “Microfluidic Manipulation of Fluids and Reactions,” published as U.S. Patent Application Publication No. 2007/0052781 on Mar. 8, 2007, all incorporated herein by reference in their entirety. In some preferred embodiments, the droplet(s) are spherical. In some embodiments, the droplet(s) are not necessarily spherical, but may assume other shapes as well, for example, depending on the external environment (e.g., a shape of a channel or microfluidic well within which a droplet is contained, etc.).

Crystals and/or particles used in the embodiments described herein may be relatively small, in some instances. For example, crystals, particles, droplets, other confined volumes, etc. described herein may have a maximum cross-sectional diameters of less than about 100 microns, less than about 10 microns, less than about 1 micron, less than about 100 nm, or smaller, or between about 20 microns and about 50 microns. In some embodiments, a plurality of crystals, particles, droplets, other confined volumes, etc. may have an average maximum cross-sectional diameter of less than about 100 microns, less than about 10 microns, less than about 1 micron, less than about 100 nm, or smaller, or between about 20 microns and about 50 microns. As used herein, the “maximum cross-sectional dimension” refers to the largest distance between two opposed boundaries of an individual structure that may be measured. The “average maximum cross-sectional dimension” of a plurality of structures refers to the number average.

In some embodiments, one or more confined volumes may be contained within a microfluidic channel or a microfluidic device. A “channel,” as used herein, means a feature on or in an article (substrate) that at least partially directs the flow of a fluid. The channel can have any cross-sectional shape (circular, oval, triangular, irregular, square or rectangular, or the like) and can be covered or uncovered. In embodiments where it is completely covered, at least one portion of the channel can have a cross-section that is completely enclosed, or the entire channel may be completely enclosed along its entire length with the exception of its inlet(s) and outlet(s). A channel may also have an aspect ratio (length to average cross sectional dimension) of at least 2:1, more typically at least 3:1, 5:1, or 10:1 or more. The “cross-sectional dimension” of a channel is measured perpendicular to the direction of fluid flow.

The channel may be of any size, for example, having a largest cross-sectional dimension of less than about 5 mm or 2 mm, or less than about 1 mm, or less than about 500 microns, less than about 200 microns, less than about 100 microns, less than about 60 microns, less than about 50 microns, less than about 40 microns, less than about 30 microns, less than about 25 microns, less than about 10 microns, less than about 3 microns, less than about 1 micron, less than about 300 nm, less than about 100 nm, less than about 30 nm, or less than about 10 nm. In some cases the dimensions of the channel may be chosen such that fluid is able to freely flow through the article or substrate. The dimensions of the channel may also be chosen, for example, to allow a certain volumetric or linear flow rate of fluid in the channel. In some embodiments, the length of the channel may be selected such that the residence times of a first and second (or more) fluids at a predetermined flow rate are sufficient to produce organic materials of a desired size or crystallographic orientation. Lengths, widths, depths, or other dimensions of channels may be chosen, in some cases, to produce a desired pressure drop along the length of a channel (e.g., when a fluid of known viscosity will be flowed through one or more channels). Of course, the number of channels and the shape of the channels can be varied by any method known to those of ordinary skill in the art.

In some, but not all embodiments, some or all components of the systems and methods described herein are microfluidic. “Microfluidic,” as used herein, refers to a device, apparatus or system including at least one fluid channel having a largest cross-sectional dimension of less than about 1 mm, and a ratio of length to largest cross-sectional dimension perpendicular to the channel of at least 3:1. A “microfluidic channel” or a “microchannel” as used herein, is a channel meeting these criteria. In one set of embodiments, all fluid channels containing embodiments of the invention are microfluidic.

In some cases, multiple sets of microfluidic channels are fabricated on a single substrate (e.g., a silicon wafer) which may be designed to handle multiple sets of fluidic inlets for parallel testing of channel intersection designs. The effects of various design parameters such as channel dimensions, channel shape, and the ratio of the dimensions of two or more channels may be simultaneously tested. One or more designs that produce one or more favorable properties (e.g., crystal size distribution, polymorphic form, etc.) may be chosen for subsequent fabrication.

A variety of materials and methods, according to certain aspects of the invention, can be used to form systems such as those described above. In some embodiments, the channel materials are selected such that the interaction between one or more channel surfaces and a particle and/or particle precursor material is minimized. Minimizing such interactions may assist in reducing the amount of particle nucleation on and/or attachment to walls of the channel, thus minimizing channel clogging. For example, when particles and/or particle precursors comprise charged particles, the channel material may be selected such that the charged materials are repelled from the channel surface. In some cases, one or more channel surface portions may be coated with a material that serves to minimize the interactions between the channel surface portion(s) and the particles and/or particle precursor materials within the channel. For example, channels may be coated with a hydrophobic material to repel water-soluble particles. Similarly, channels may be coated, in some embodiments, with hydrophilic material to repel water-insoluble particles. For example, silicon channels, which are hydrophilic, may not interact very much with aspirin, a hydrophobic active ingredient. In another case, for example, fluorosilane-coated channels, which are hydrophobic, may not interact very much with glycine, a hydrophilic organic compound.

In some embodiments, the fluid channels may comprise tubing such as, for example, flexible tubes (e.g., PEEK tubing), capillary tubes (e.g., glass capillary tubes), and the like. In some embodiments, various components can be formed from solid materials, in which microfluidic channels can be formed via micromachining, film deposition processes such as spin coating and chemical vapor deposition, laser fabrication, photolithographic techniques, etching methods including wet chemical or plasma processes, and the like. See, for example, Scientific American, 248:44-55, 1983 (Angell, et al). In one set of embodiments, at least a portion of the fluidic system is formed of silicon by etching features in a silicon chip. Enclosed channels may be formed, for example, by bonding a layer of material (e.g., polymer, Pyrex®, etc.) over the etched channels in the silicon. Technologies for precise and efficient fabrication of various fluidic systems and devices of the invention from silicon are known. In another embodiment, various components of the systems and devices of the invention can be formed of a polymer, for example, poly(dimethylsiloxane) (PDMS), PMMA, PTFE, PEEK and Teflon, cyclic olefin copolymers (COC) such as TOPAS. In some cases, various components of the system may be formed in other materials such as metal, ceramic, glass, Pyrex®, etc. In some embodiments, various components of the system may be formed of composites of these materials herein.

Different components can be fabricated of different materials. For example, a base portion including a bottom wall and side walls can be fabricated from a transparent or at least partially transparent material, such as glass or a transparent polymer, for observation and/or control of the fluidic process, and a top portion can be fabricated from an opaque material such as silicon. Components can be coated so as to expose a desired chemical functionality to fluids that contact interior channel walls, where the base supporting material does not have a precise, desired functionality. For example, components can be fabricated as illustrated, with interior channel walls coated with another material. Material used to fabricate various components of the systems and devices of the invention, e.g., materials used to coat interior walls of fluid channels, may desirably be selected from among those materials that will not adversely affect or be affected by fluid flowing through the fluidic system, e.g., material(s) that is chemically inert in the presence of fluids to be used within the device.

In one embodiment, various components of the invention are fabricated from polymeric materials, and can be conveniently formed of a hardenable fluid, facilitating fabrication via molding (e.g. replica molding, injection molding, cast molding, etc.). The hardenable fluid can be essentially any fluid that can be induced to solidify, or that spontaneously solidifies, into a solid capable of containing and/or transporting fluids contemplated for use in and with the fluidic network. In one embodiment, the hardenable fluid comprises a polymeric liquid or a liquid polymeric precursor (i.e. a “prepolymer”). Suitable polymeric liquids can include, for example, thermoplastic polymers, thermoset polymers, or mixture of such polymers heated above their melting point. As another example, a suitable polymeric liquid may include a solution of one or more polymers in a suitable solvent, which solution forms a solid polymeric material upon removal of the solvent, for example, by evaporation. Such polymeric materials, which can be solidified from, for example, a melt state or by solvent evaporation, are well known to those of ordinary skill in the art. A variety of polymeric materials, many of which are elastomeric, are also suitable for forming molds or mold masters, for embodiments where one or both of the mold masters is composed of an elastomeric material. A non-limiting list of examples of such polymers includes polymers of the general classes of silicone polymers, epoxy polymers, and acrylate polymers. Epoxy polymers are characterized by the presence of a three-membered cyclic ether group commonly referred to as an epoxy group, 1,2-epoxide, or oxirane. For example, diglycidyl ethers of bisphenol A can be used, in addition to compounds based on aromatic amine, triazine, and cycloaliphatic backbones. Another example includes the well-known Novolac polymers. Non-limiting examples of silicone elastomers suitable for use according to the invention include those formed from precursors including the chlorosilanes such as methylchlorosilanes, ethylchlorosilanes, phenylchlorosilanes, etc.

Silicone polymers can be used in one set of embodiments, for example, the silicone elastomer polydimethylsiloxane. Non-limiting examples of PDMS polymers include those sold under the trademark Sylgard by Dow Chemical Co., Midland, Mich., and particularly Sylgard 182, Sylgard 184, and Sylgard 186. Silicone polymers including PDMS have several beneficial properties simplifying fabrication of the microfluidic structures of the invention. For instance, such materials are inexpensive, readily available, and can be solidified from a prepolymeric liquid via curing with heat. For example, PDMSs are typically curable by exposure of the prepolymeric liquid to temperatures of about, for example, about 65° C. to about 85° C. for exposure times of, for example, about two hours. Also, silicone polymers, such as PDMS, can be elastomeric, and thus may be useful for forming very small features with relatively high aspect ratios, necessary in certain embodiments of the invention. Flexible (e.g., elastomeric) molds or masters can be advantageous in this regard.

One advantage of forming structures such as microfluidic structures of the invention from silicone polymers, such as PDMS, is the ability of such polymers to be oxidized, for example by exposure to an oxygen-containing plasma such as an air plasma, so that the oxidized structures contain, at their surface, chemical groups capable of cross-linking to other oxidized silicone polymer surfaces or to the oxidized surfaces of a variety of other polymeric and non-polymeric materials. Thus, components can be fabricated and then oxidized and essentially irreversibly sealed to other silicone polymer surfaces, or to the surfaces of other substrates reactive with the oxidized silicone polymer surfaces, without the need for separate adhesives or other sealing means. In most cases, sealing can be completed simply by contacting an oxidized silicone surface to another surface without the need to apply auxiliary pressure to form the seal. That is, the pre-oxidized silicone surface acts as a contact adhesive against suitable mating surfaces. Specifically, in addition to being irreversibly sealable to itself, oxidized silicone such as oxidized PDMS can also be sealed irreversibly to a range of oxidized materials other than itself including, for example, glass, silicon, silicon oxide, quartz, silicon nitride, polyethylene, polystyrene, glassy carbon, and epoxy polymers, which have been oxidized in a similar fashion to the PDMS surface (for example, via exposure to an oxygen-containing plasma). Oxidation and sealing methods useful in the context of the present invention, as well as overall molding techniques, are described in the art, for example, in an article entitled “Rapid Prototyping of Microfluidic Systems and Polydimethylsiloxane,” Anal. Chem., 70:474-480, 1998 (Duffy, et al.), incorporated herein by reference.

In some embodiments, certain microfluidic structures of the invention (or interior, fluid-contacting surfaces) may be formed from certain oxidized silicone polymers. Such surfaces may be more hydrophilic than the surface of an elastomeric polymer. Such hydrophilic channel surfaces can thus be more easily filled and wetted with aqueous solutions.

In one embodiment, a bottom wall of a microfluidic device of the invention is formed of a material different from one or more side walls or a top wall, or other components. For example, the interior surface of a bottom wall can comprise the surface of a silicon wafer or microchip, or other substrate. Other components can, as described above, be sealed to such alternative substrates. Where it is desired to seal a component comprising a silicone polymer (e.g. PDMS) to a substrate (bottom wall) of different material, the substrate may be selected from the group of materials to which oxidized silicone polymer is able to irreversibly seal (e.g., glass, silicon, silicon oxide, quartz, silicon nitride, polyethylene, polystyrene, epoxy polymers, and glassy carbon surfaces which have been oxidized). Alternatively, other sealing techniques can be used, as would be apparent to those of ordinary skill in the art, including, but not limited to, the use of separate adhesives, bonding, solvent bonding, ultrasonic welding, etc.

The term “determining,” as used herein, generally refers to the analysis or measurement of a confined volume (e.g., droplet), for example, quantitatively or qualitatively, and/or the detection of the presence, absence, or amount of a species, property, or condition within a confined volume. In some embodiments, determining may comprise visual inspection to determine the presence and/or number of a species (e.g., a crystal, particle, etc.). Examples of suitable determining techniques include, but are not limited to, x-ray diffraction, spectroscopy such as infrared, absorption, fluorescence, UV/visible, FTIR (“Fourier Transform Infrared Spectroscopy”), or Raman; optical measurements such as optical microscopy or optical density measurements; circular dichroism; light scattering measurements such as quasielectric light scattering; polarimetry; refractometry; or turbidity measurements. In some embodiments, at least a portion of the device in which the crystals are contained is transparent to at least one wavelength of electromagnetic radiation (e.g., x-rays, ultraviolet, visible, IR, etc.) allowing interrogation of the particle. Systems used to determine confined volumes may be interfaced with a computer to allow for real-time analysis. For example, diffraction patterns associated with crystals may be analyzed in real-time using analysis software.

In some cases, a plurality of crystals may be interrogated with radiation to produce a plurality of diffraction patterns, after which a crystal structure may be determined based at least in part on the plurality of diffraction patterns. In some embodiments, the crystals may be relatively small, and thus, difficult to interrogate with radiation without damaging or destroying the crystal. Traditionally, small crystals have been difficult to analyze using x-ray diffraction techniques. Consequently, small crystals must often be grown to larger sizes, requiring scale-up of the crystallization conditions. Often, the crystals are then harvested, cryoprotected, and oriented in a synchrotron beam. The systems and methods described herein may exhibit one or more advantages compared to traditional crystal analysis methods. For example, one or more crystals can be oriented substantially at random prior to interrogating the first and second crystals. This may eliminate the need for alignment of the crystals prior to interrogation. In some cases, one or more crystals may not be cryoprotected prior to interrogation. Cryoprotection may comprise, for example, exposure to not exposed to dimethyl siloxide (DMSO), ethylene glycol, glycerol, propylene glycol, sucrose, or trehalose, and the like. In addition, relatively small crystals can be employed in some cases, and, therefore, may not require a time-consuming and/or expensive crystal growth step.

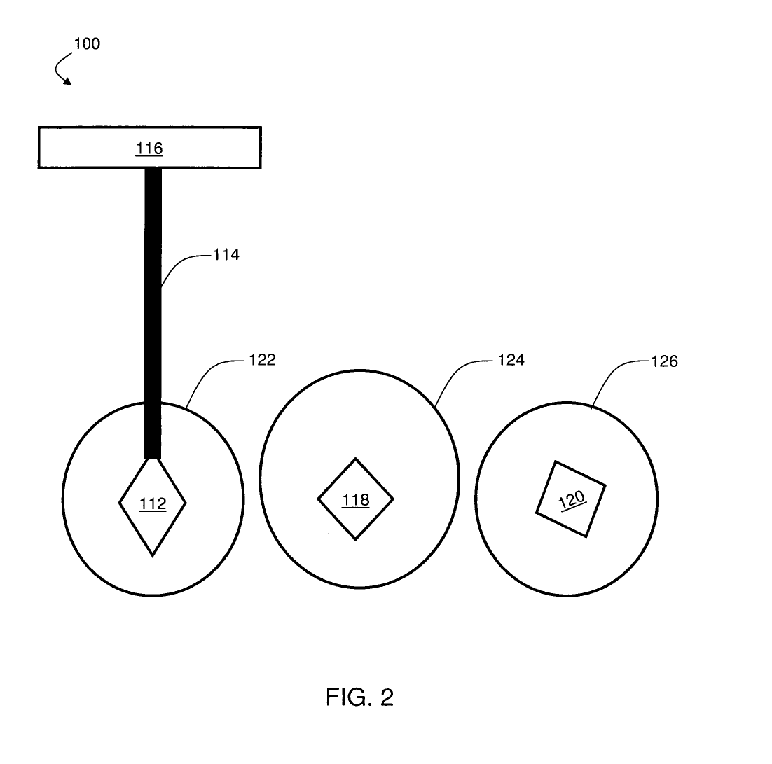

In some cases, a first crystal can be interrogated to produce a first diffraction pattern, a second crystal can be interrogated to produce a second diffraction pattern, and a crystal structure can be determined based at least in part on the first and second diffraction patterns. In some embodiments, the interrogation step may comprise, for example, x-ray diffraction. FIG. 2 includes a schematic illustration of system 100 which may be used to determine a crystal structure. In this exemplary embodiment, crystal 102 may be interrogated using beam 104 of electromagnetic radiation (e.g., an x-ray) from radiation source 106. Such a source may comprise, for example, an x-ray diffraction apparatus, or any other suitable source. Suitable methods for producing diffraction patterns using radiation are known to those of ordinary skill in the art and include, for example, x-ray diffraction techniques. Referring back to FIG. 2, the crystallographic orientation of crystal 108 may also be determined, for example, using a beam 104 from radiation source 106. A crystal structure may then be determined based at least in part on the first and second diffraction patterns.

In some embodiments, more than two crystals may be analyzed. For example, in FIG. 2, a third crystal 120 may be interrogated with radiation from beam 114 to produce a third diffraction pattern. The third diffraction pattern may then be used, along with the first two diffraction patterns, to determine a crystal structure. In some embodiments, at least about 10 crystals, at least about 100 crystals, at least about 1000 crystals, at least about 10,000 crystals, or at least about 100,000 crystals may be interrogated to produce diffraction patterns, and a crystal structure may be determined based at least in part on the diffraction patterns.

In some embodiments, one or more crystals may be contained within a droplet. For example, in some cases, at least one of the first and second crystals is contained within a droplet. In some embodiments, the first crystal is contained within a first droplet, and the second crystal is contained within a second droplet. In some cases, each of the plurality of droplets may contain substantially a single crystal. For example, in the exemplary embodiment of FIG. 2, first crystal 112 is contained within optional first droplet 122, second crystal 118 is contained within optional second droplet 124, and third crystal 120 may be contained within optional third droplet 126.

In some cases, at least one of the first and second crystals is altered during the interrogation of the crystal (e.g., during x-ray diffraction). For example, the radiation may alter the crystal structure or destroy the crystal entirely.

Multiple crystal containing droplets can, in some instances, flow through a microfluidic device into a diffraction capillary. A droplet can be momentarily stopped in a beam of radiation, diffraction data can be collected, and the droplet can be removed while the next drop is transported into the beam. Each small crystal can have a random orientation in the beam, and therefore each crystal can produce an independent diffraction pattern. A single x-ray exposure can be adequate to determine the crystal orientation matrix, which is necessary to merge data into a single complete data set. A data set for structural analysis can be assembled from the collection of individual diffraction patterns. Because the crystals are not necessarily cryoprotected, they may suffer radiation damage. However, in such embodiments, substantially no artifacts may be introduced by a cryoprotection process, and one or more of the labor intensive steps of scale up of crystallization conditions, cyroprotection, and crystal alignment may be eliminated, thereby shortening the structure pipeline. Multiple (e.g., tens, hundreds, thousands, etc.) of low quality diffraction patterns from different, randomly-oriented small crystals may be combined in some cases to produce high-quality structures obtained in a high-throughput fashion.

The term “interrogating,” as used herein, generally refers to the analysis or measurement of a crystal, for example, quantitatively or qualitatively, and/or the detection of the presence or absence of the species, property, or condition. Examples of suitable interrogating techniques include any of the exemplary determining techniques mentioned above.

Crystals described herein may comprise a variety of materials including, but not limited to proteins (e.g., human membrane proteins such as G protein-coupled receptors), pharmaceuticals (e.g. ibuprofen, celcoxib, rofecoxib, valdecoxib, naproxen, meloxicam, aspirin, diclofenac, hydrocodone, propoxyphene, oxycodone, codeine, tramadol, fentanyl, morphine, meperidine, cyclobenzaprine, carisoprodol, metaxalone, chlorpheniramine, promethazine, methocarbamol, gabapentin, clonazepam, valproic acid, phenytoin, diazepam, topiramate, sumatriptan, lamotrigine, oxcarbanepine, phenobarbital, sertraline, paroxetine, fluoxetine, venlafaxine, citalopram, bupropion, amitriptyline, escitalopram, trazodone, mirtanapine, zolpidem, risperidone, olanzapine, quetiapine, promethazine, meclizine, metoclopramide, hydroxyzine, zaleplon, alprazolam, lorazepam, amphetamine, methylphenidate, temazepam, donepexil, atomoxetine, buspirone, lithium carbonate, carbidopa, amoxicillin, cephalexin, penicillin, cefdinir, cefprozil, cefuroxime, ceftriaxone, vancomycin, clindamycin, azithromycin, ciprofloxacin, levofloxacin, trimethoprim, clarithromycin, nitrofurantoin, doxycycline, moxifloxicin, gatifloxacin, tetracycline, erythromycin, fluconazole, valacyclovir, terbinafine, metronidazole, acyclovir, amphotericin, metformin, glipizide, pioglitazone, glyburide, rosiglitazone, glimepiride, metformin, octreotide, glucagon, insulin, human insulin NPH, glargine (insulin), lispro (insulin), aspart (insulin), levothyroxine, prednisone, allopurinol, methylprednisolone, liothyronine, somatropin, colchicine, sulfamerazine, lovastatin, caffeine, cholesterol, lidocaine, strimasterol, theophyllin, acetaminophen, albumin, sporanic acid, lysozyme, mefenamic acid, paracetamol, salmeterol xinafoate, salbutamol, tetracycline or derivatives or parents of the above-mentioned compounds), protein drugs (e.g. interferon, leuprolide, infliximab, trastuzumab, filgastrim, goserelin etc.) pigments (e.g., bronze red, quinacridone etc.), small organic molecules (e.g. glycine, glutamic acid, methionine, flufenamic acid etc.), and explosives (e.g. cyclotrimetylenetri-nitramine, nitroguanidine etc.).

The following example is intended to illustrate certain embodiments of the present invention, but does not exemplify the full scope of the invention.

### EXAMPLE

X-ray diffraction of protein crystals is a prominent technique for protein structure determination, with the crystallization process remaining a major bottleneck in the structure pipeline. The systems and methods described herein may be used to reduce the extent to which crystallization is a bottleneck in such systems. Currently, the production facilities of the Protein Structure Initiative find that two thirds of purified proteins fail to produce diffraction quality protein crystals and one third of their resources are devoted to salvaging proteins that produce promising crystals, but fail to diffract x-rays. The Crystal Optimizer (XOp) described herein is designed to salvage near misses and optimize the crystallization kinetics by systematically varying the kinetic supersaturation profile of the crystallization solution. Using the Shotgun Diffraction chip (ShDi), problems associated with cryoprotection and scale-up of crystallization conditions from microfluidic to traditional methods can be reduced.

Although protein crystallography can be a very successful technique for structure determination, membrane proteins continue to present challenges to crystallization. Of the human membrane proteins, representing one third of the genome, only a few have had their structure solved using x-ray diffraction. In many cases, the number of crystallization trials is limited by the availability of human protein, which doesn't express well in bacteria, hence the drive to minimize sample volume. The technology developed in this example can be used to crystallize proteins on the salvage pathway (promising crystals that fail to yield structures), including human membrane G-protein-coupled receptors. Given the paucity of crystallized human membrane proteins and the fact that 50% of marketed drugs target GPCRs, theses systems and methods have the potential to greatly impact fields such as structural biology and pharmaceutical development.

### Conceptual Framework

The paradigm guiding many crystallization efforts is that the conditions for which an equilibrium crystal phase exists are a small subset among a vastly larger set of parameters such as protein concentration, pH, various salts, polymers, temperature, and surfactants. However, it is not widely appreciated that finding the correct equilibrium conditions, while a necessary condition, is not sufficient to produce crystals because crystallization is a non-equilibrium process. Consequently, crystallization methods that focus on screening large number of conditions are incomplete. Additionally, it may be helpful to optimize the non-equilibrium kinetics of protein crystallization and exploit the crystals that are produced by these methods in order to obtain high quality diffraction data.

Under many current methods, protein crystals are produced by trial and error, which necessitates exploring a large number of conditions consuming milligrams of protein. Many methods employed in small non-automated labs require about 1 microliter of solution per trial. Automation with expensive robotics has lowered volumes to the 100 nL range in some instances. Microfluidic devices can reduce the volume per trial to 1 nL or less in many instances. Such small volumes prove useful to screen conditions. However, when crystals are produced in 1 nL drops, they can be less than 30 microns in diameter, which may be too small for current diffraction methods. Scale-up from microfluidic systems also may involve different physics and can be difficult. Even if large crystals are obtained, then they may be required to be cryoprotected, which can damage crystals. Finally the crystals must be aligned in the x-ray beam in many systems.

This example describes systems and methods that improve diffraction methods. The Crystal Optimizer (XOp) addresses the problem of crystal creation by determining favorable conditions for crystallization using microfluidics. In addition, with the Shotgun Diffraction (ShDi) method, high resolution structures from small, non-cryoprotected crystals produced in the XOp can be obtained.

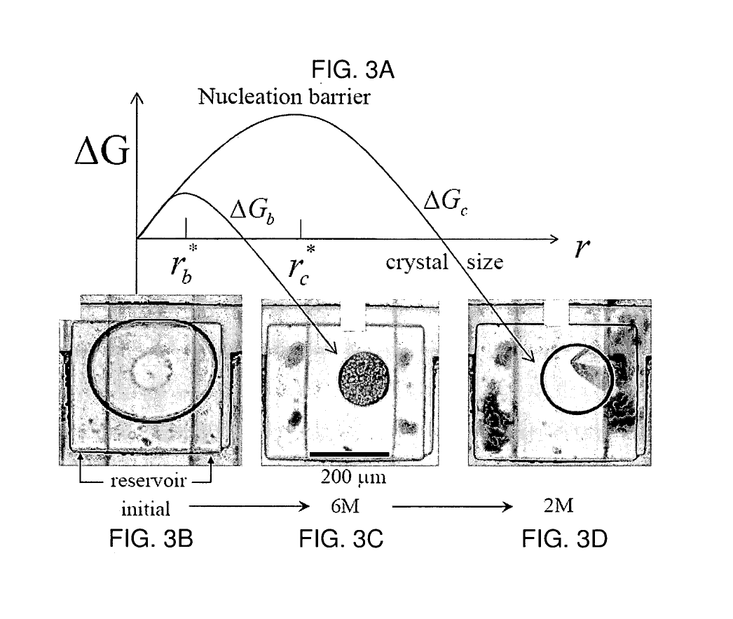

Recently attention has turned to understanding the underlying phase behavior of protein crystallization as a rational approach. However, even knowledge of the equilibrium phase behavior may not be enough to produce crystals, because crystallization, in general, is an activated process. Even when the protein solution is supersaturated so that the chemical potential of a protein molecule in the liquid is greater than in the crystal (Δμ>0), a small crystal will be unstable. Due to the surface tension, γ, between the crystal and the fluid there is an energy barrier, ΔG*, that causes crystals below a certain size to dissolve. The free energy (ΔG) of a spherical protein crystal nucleus of radius r is ΔG=γ4πr²−Δμ4πr³/V with V the protein volume, leading to a barrier of height ΔG*=16 πγ³V²/3Δμ² that occurs at a radius r*=2γV/Δμ as shown in FIG. 3A. Crystals that spontaneously form with a radius r<r* lower their free energy by dissolving and only crystals larger than r* grow. The free energy barrier often is quite large for proteins. To overcome this barrier and achieve a finite nucleation rate Γ˜exp(−ΔG*/kT), protein solutions in crystallization conditions must be highly supersaturated. This is because Δμ˜ln c , with c the protein concentration. However, under these circumstances, both the nucleation and growth rate are high, which may lead to the formation of many small and defect laden crystals that are unsuitable for x-ray diffraction. The conundrum facing the crystallographer is that while the nucleation of crystals may require high supersaturation, the converse is true to grow large, defect-free crystals.

A possible solution to this problem is to change sample conditions during the crystallization process. Good crystal growing conditions occur when the sample is temporarily brought into deep supersaturation (a process referred to as quenching) where the nucleation rate is high enough to be tolerable. In one particularly favorable scenario, after a single crystal has nucleated the supersaturation of the solution would be decreased by either lowering the protein or salt concentrations, or by raising temperature in order to suppress further crystal nucleation and to establish conditions where slow, defect free crystal growth occurs. In other words, independent control of nucleation and growth may be desired. Many current approaches to crystal screening rely on exploring large number of chemical compositions and temperature, which are the equilibrium thermodynamic variables. But as just discussed, crystallization is a non-equilibrium activated process controlled by the nucleation rate. This means that the amount and time duration of supersaturation of the protein solution are important quantities, even though time is not a thermodynamic variable. The Crystal Optimizer may be used to systematically treat quench depth and time as key screening parameters to be optimized as illustrated in FIGS. 3A-3D.

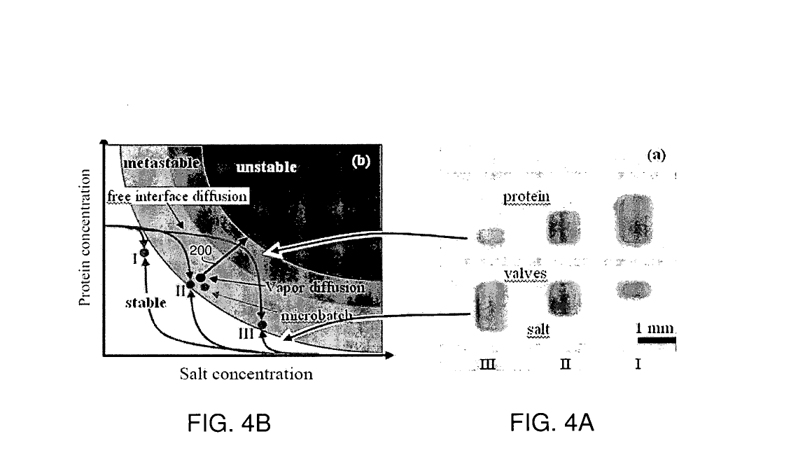

Not wishing to be bound by any theory, the phase behavior of protein solutions may be partially explained using FIGS. 4A-4B. In these figures, for low protein concentration, the solution is thermodynamically stable. An increase in concentration of a precipitant, such as salt or poly(ethylene) glycol (PEG), can drive the protein into a region of the phase diagram where the solution is metastable and protein crystals are stable. In this region there may be a free energy barrier to nucleating protein crystals and the nucleation rate can be extremely slow (FIGS. 3A-3D). At higher concentrations the nucleation barrier is suppressed and homogeneous nucleation rapidly occurs, which as described previously leads to many poor quality crystals.

The volume of the drop can play an important role in protein crystallization. If the supersaturated drop is small enough, then once the first crystal nucleates the supersaturation of the entire drop may significantly decrease as the growing crystal consumes protein in solution, preventing subsequent nucleation. The desirable outcome of one crystal per drop occurs when the time for the crystal to grow to its maximum possible size (τ_{G}) is less than the time to nucleate a crystal (τ_{N}), or τ_{G}/τ_{N}<<1. Since τ_{N} is inversely proportional to the total volume, and τ_{G} increases with volume then decreasing the volume of the drops also decreases τ_{G}/τ_{N}. All things equal, smaller drops have a greater probability of having a single crystal than larger drops.

In some cases, two open containers, one with a microliter of protein solution and the other with a milliliter of a salt solution, can be placed together in a sealed vessel such that the solutions are in contact only through the vapor phase. If the salts, proteins, and polymers are non-volatile, then only water exchanges between the protein solution and reservoir until equilibrium is reached at which point the chemical potentials of water in the protein solution, reservoir, and vapor are equal. For example, if the protein-free reservoir is saltier than the protein solution then water will leave the protein solution until its chemical potential is the same as the reservoir. As water leaves the protein solution all the components are concentrated and the protein solution follows the trajectory of black arrow 200 in FIG. 4B. Depending on the reservoir osmolity, the protein solution can be either concentrated or diluted (the direction of the arrow can be reversed). Similar to Free Interface Diffusion (FIGS. 4A-4B), vapor diffusion works by quenching protein solutions deep into supersaturation and relies on the growth of nucleated crystals to locally lower the supersaturation so as to inhibit further nucleation. Also similar to free interface diffusion, vapor diffusion is irreversible. By physically changing the reservoir osmolity, the vapor diffusion method can be made to reversibly vary supersaturation, however this process has not been automated.

It should be noted that protein crystallization methods are dynamic even if this dynamism is not actively controlled by the experimenter. While mixing together reagents and proteins of the correct concentration to form crystals is a necessary condition, it may not be sufficient to produce single, high quality crystals. It may be advantageous, in many circumstances, to actively or passively incorporate dynamic control of nucleation and growth.

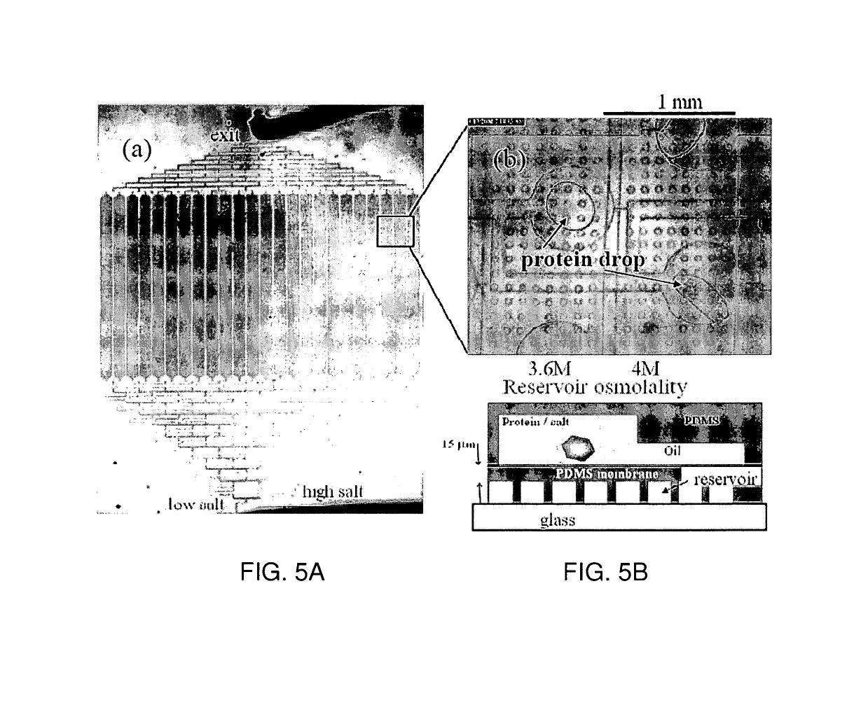

The systems and methods described herein improve crystal nucleation and growth actively under the systematic and intentional control of the experimenter. First, a specific mixture of protein and precipitation agents, such as salts and PEG, may be formulated. For example, this would typically be the lead candidate from a traditional microbatch or vapor diffusion screen that failed to produce diffraction quality crystals, but instead yielded crystal showers, small crystals, precipitates, gels or liquid-liquid separation, known as “oiling-out.” Then, through external manipulation of the microfluidic crystal optimizing chip (XOp) the temperature and composition of each of a plurality (e.g., 10,000) of drops will be systematically and simultaneously varied through different temporal variations of supersaturation, or quench profiles. The objective of the XOp is to find an advantageous kinetic trajectory through different supersaturation values that transforms a protein solution into a single crystal. After achieving this goal, the plurality of drops of protein solution will be processed in parallel according to the optimal kinetic path, producing a plurality of drops of which each contains a single crystal. Finally the drops will be fed into a second microfluidic device designed for diffraction, the ShDi, which will pass the drops one at a time into a synchrotron beam optimized for diffraction from 50 micron diameter crystals. In the analysis stage following data acquisition a relatively high quality diffraction data set will be assembled from the thousands of relatively poor quality individual diffraction images. Each of these steps are illustrated in FIGS. 5-10 and discussed in the next section.

### Crystal Optimizer

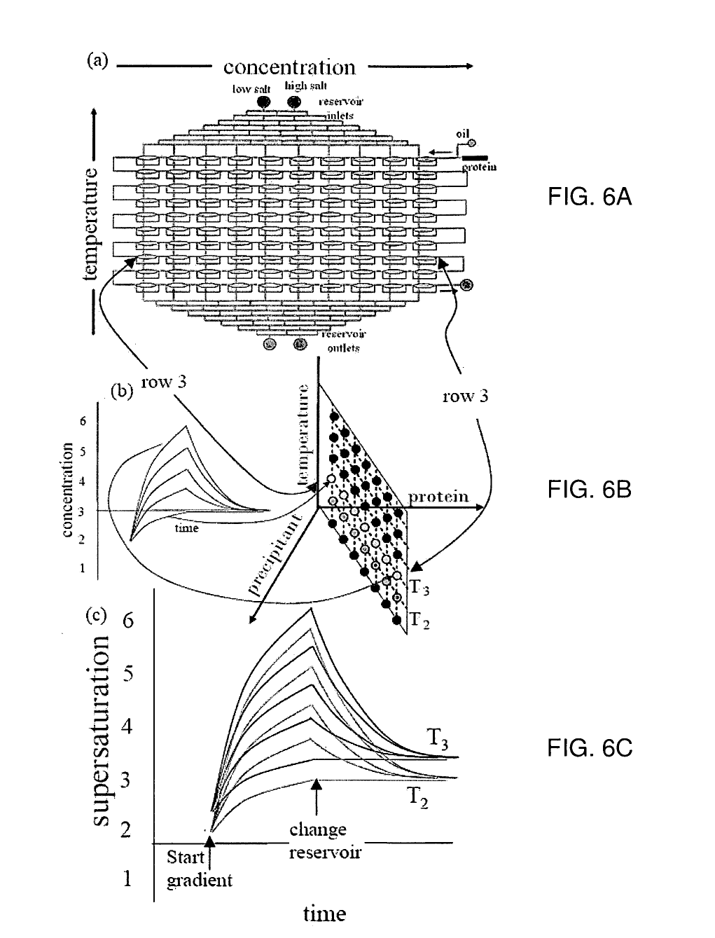

The first generation Crystal Optimizer (XOp) has been fabricated. Concentration can be controlled using a two-layer polydimethylsiloxane (PDMS) microfluidic chip called the PhaseChip which was previously developed at Brandeis and illustrated in FIGS. 5A-5B. The monodisperse protein drops can be prepared using standard flow focusing microfluidics and can be stabilized using a proprietary per-fluoro polyether surfactant synthesized by RDT that is essentially identical to one described in the literature. (See C. Holtze, A. C. Rowat, J. J. Agresti, J. B. Hutchison, F. E. Angilè, C. H. J. Schmitz, S. Köster, H. Duan, K. J. Humphry, R. A. Scanga, J. S. Johnson, D. Pisignano, and D. A. Weitz. “Biocompatible surfactants for water-influorocarbon emulsions,” Lab on a Chip 8, 1632-39 (2008)) This tri-block surfactant has two high molecular weight PEG end-blocks separated by a fluorinated middle block. The surfactant sits at the oil-water interface with the protein exposed to the PEG blocks. Two aqueous drops are prevented from coalescing by the middle fluorinated block. The protein solution can be stored on chip as aqueous drops surrounded by a continuous phase of inert fluorinated oil in wells in the upper level while a salt solution is stored in a chemical potential reservoir below. A PDMS membrane, permeable only to water and not salt or protein separates the protein from the reservoir. When the chemical potentials of water are different between the protein drops and reservoir then water will flow between them. If water flows in (out) of the protein drop, the protein solution can decrease (increase) concentration. Because salt and PEG, as well as protein, do not permeate through the PDMS, as water flows out of the protein drop all the solute concentrations increase linearly (if the protein drop shrinks in half, then the salt and protein concentration inside the drop double). FIG. 5A shows how a large number of reservoirs are filled with different salt solutions using a flow-splitting design that produces a linear concentration gradient developed by the Whitesides group. (See S. K. W. Dertinger, D. T. Chiu, N. L. Jeon, and G. M. Whitesides. “Generation of gradients having complex shapes using microfluidic networks,” Analytical Chemistry 73, 1240-46 (2001)) In FIG. 5B protein solutions above a 3.6M reservoir remain in a single phase, while drops located over an adjacent reservoir of 4.0M are slightly more concentrated and have undergone a liquid-liquid phase separation (oiling-out). If the PhaseChip, which can generate a composition gradient in one direction, is placed on a temperature stage designed to produce a linear gradient in temperature, then a device (the XOp) that can produce a matrix of protein drops in the composition-temperature plane can be produced. A schematic of the XOp is shown in FIG. 6A.

Kinetic pathways can be generated by changing the salt gradient in the reservoir. FIGS. 6A-6C explain how one might envision a typical protocol for the XOp chip. In FIG. 6A the XOp is shown loaded with drops all of the same composition. FIG. 6B illustrates the following thought experiment.

Imagine at time t=0 introducing a gradient in salt concentration in the reservoir. Protein drops over the high salt end of the reservoir might shrink rapidly in response to the large osmotic stress and protein drops over the low salt end of the reservoir might shrink slowly. The purpose of this step is to nucleate a single crystal in some of the drops. Then, after some time, fill the entire reservoir with the same salt concentration and therefore all the drops will swell to the same final concentration, which can be different than the initial concentration. The purpose of this step is to grow crystals slowly to allow time for defects to anneal. The temporal variation of the concentration of solutes in the drops is shown for one row in FIG. 6B, but is substantially identical for all rows. However, drops in different rows are at different temperatures. Imagine that the temperature gradient is fixed in time. Then since supersaturation is a function of temperature each row of drops will be at different levels of supersaturation. The temporal evolution of two rows of drops is illustrated in FIG. 6C. Thus each drop on the XOp will follow a different kinetic supersaturation pathway. Note that the sequence can be reversed; first a steady state composition gradient can be generated by setting a gradient in salt concentration across the reservoir that is constant in time. Then a gradient in temperature can be imposed for a fixed time interval and finally the temperature can be set to a final value, lower from the initial temperature. This will generate a different set of kinetic trajectories then illustrated in FIGS. 6A-6C.

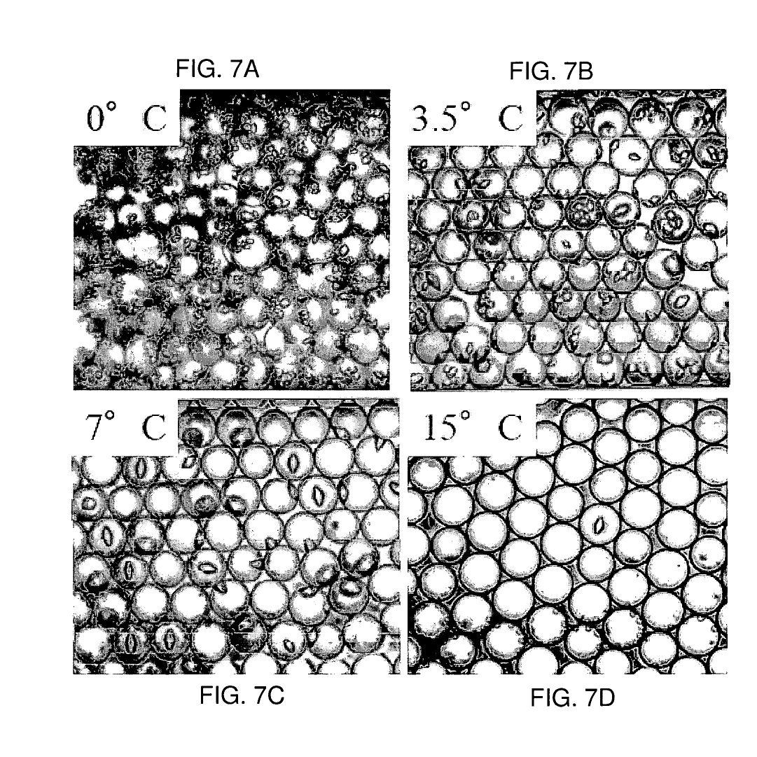

FIGS. 7A-7D shows drops containing lysozyme of the same composition at four temperatures. These photos were taken from drops stored in a glass capillary placed on our temperature gradient stage. There is a clear pattern in the number of crystals per drop; many crystals at 0° C. (FIG. 7A), one or no crystals per drop at 7° C. (FIG. 7C), and almost no crystals at 15° C. (FIG. 7D).

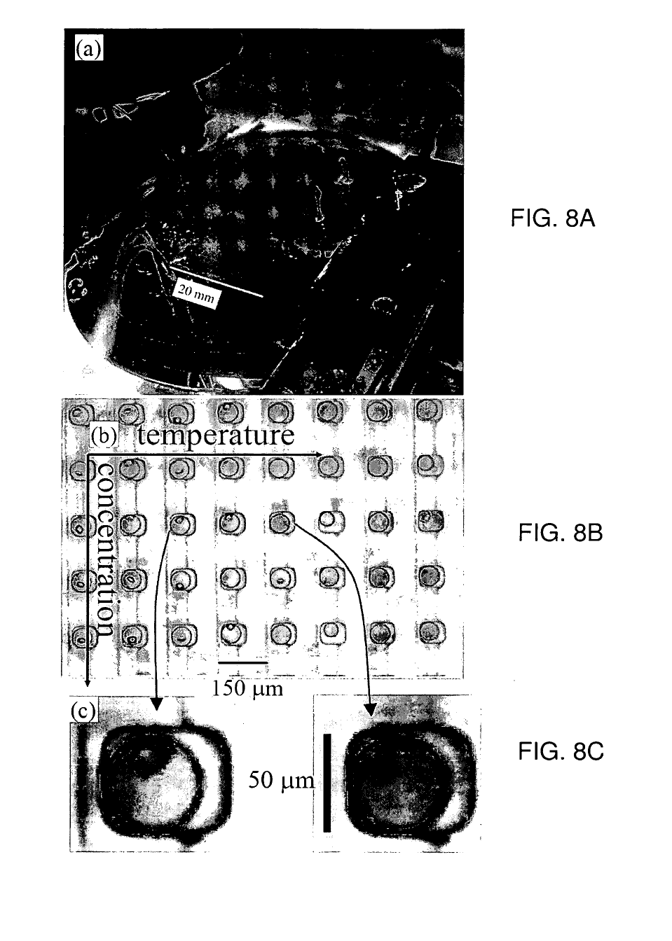

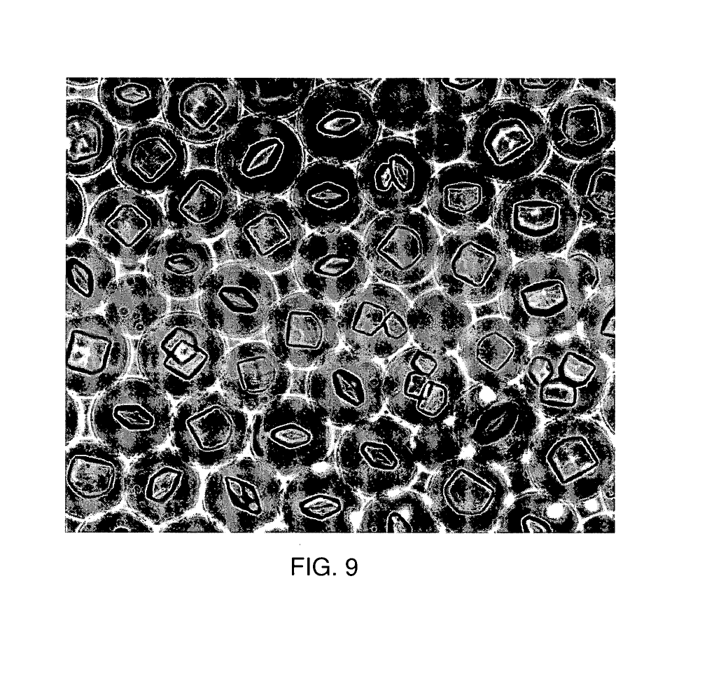

Finally, in FIG. 8A, the first experiment of the XOp is shown, comprising a PDMS chip mounted on a silicon wafer placed on top of our temperature gradient stage. Drops of 50 micron diameter have been routinely made, and chips with up to 10⁴ drops per square inch have been made, as shown in FIG. 8B. The temperature gradient was 1° C./mm. In FIG. 8B one can see that there is a transition zone from one crystal per drop to no crystals per drop over a few tenths of a degree. Lysozyme has been used to perform experiments, which, due to its propensity to crystallize, is not a typical protein. However, lysozyme's virtues are its low cost and well characterized crystallization parameters. Many other proteins of interest could also be screened, including membrane proteins. After identifying a set of conditions in the composition-temperature plane, an emulsion of identical protein drops off-chip were prepared in a vial shown in FIG. 9.

### X-Ray Diffraction

Using the standard data collection strategy of monochromatic rotation, a mounted crystal can be rotated through an angle to bring different reflections into the Bragg diffracting orientation. The amount of rotation to be covered for a full data set will depend on the crystal's space group; the worst case scenario for a triclinic crystal is generally 180 degrees. A single exposure can typically cover a rotation of about one degree. The rotation possible in each image may be limited by the need to avoid overlapping reflections, a limitation which may become more severe with long unit cell dimensions and high mosaicity. Thus, a typical complete data set adequate to solve a structure may require 50 to 200 x-ray exposures.

Before the invention of cryocrystallography, data was collected at room temperature, and radiation damage limited the amount of data that could be collected from a single crystal. Thus, data were usually collected from many crystals and scaled together to obtain complete data sets.

Cryocrystallography can reduce the radiation damage threshold by factors of 100 to 1000, allowing complete data sets to be collected with a single crystal. However, as synchrotron sources have become brighter, it has become feasible to work with smaller and smaller crystals. Whereas several years ago a typical crystal was about 200 microns across, ˜50 micron crystals are now routinely used. Synchrotron sources are now sufficiently bright to work with crystals only a micron across, were it not for the fact that below crystal sizes a few tens of microns across radiation damage prevents collection of complete data sets on single crystals, even if cryoprotected. Many estimates put the lower limit of crystal size for diffraction at about 20 microns.

In many cases, it is easier to obtain many tiny crystals than a few larger crystals, which is one motivation behind development of the XOp. This has renewed interest in obtaining complete data sets from a large number of small crystals, the motivation behind our proposed Shotgun Diffraction methodology. A single x-ray exposure can be adequate to determine the crystal orientation matrix, which can be necessary to merge data into a single complete data set. Thus, one can imagine acquiring a succession of exposures from a host of very small, randomly oriented crystals to form the complete data set. The use of room temperature should also circumvent known difficulties in scaling together data from multiple crystals which have been cryo-cooled. These problems may arise from the well known fact that the variance in unit cell sizes increases when crystals are cryo-cooled. On the other hand, radiation damage is usually dramatically worse for unfrozen crystals because of radiation-induced free radicals can diffuse about and destroy peptide bonds. One could experimentally determine the minimum crystal size that yields a high quality diffraction image for a single fixed orientation; one could use, in many cases, up to thousands of crystals per structure.

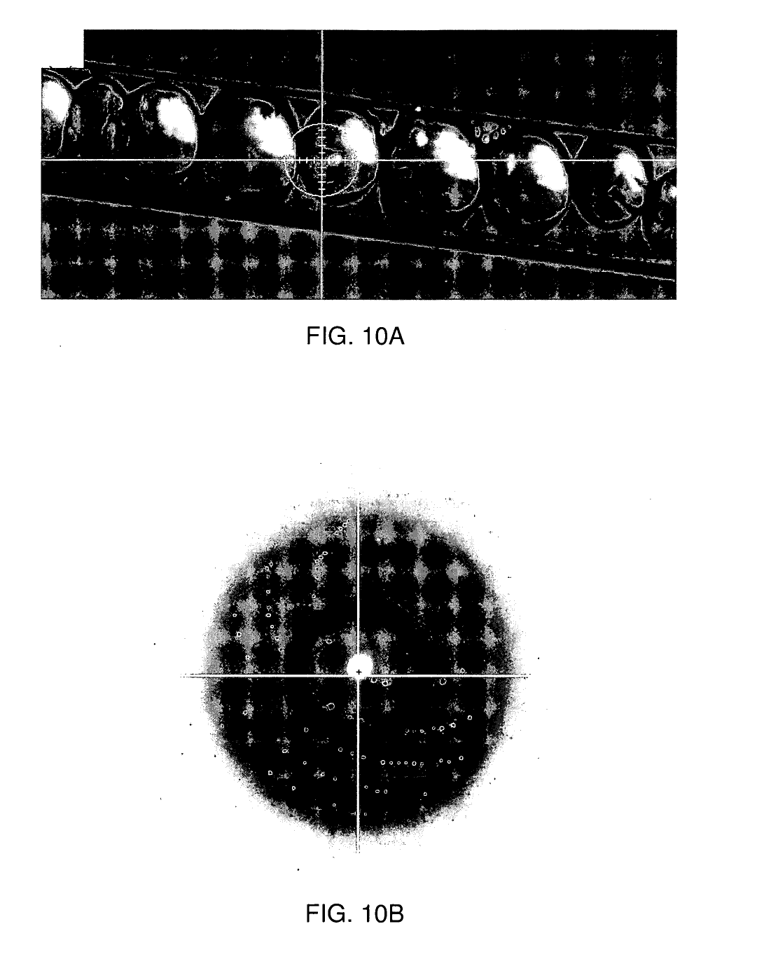

As proof of concept for the Shotgun Diffraction method (ShDi), quartz x-ray capillaries of 200 micron diameter were loaded with crystal bearing drops similar to those depicted in FIG. 9. Diffraction patterns obtained on beam line Fl with a 100 micron beam are shown in FIG. 10B. A plurality of diffraction patterns (e.g., at least two, tens, hundreds, thousands, etc.) could be acquired from individual drops and software and algorithms could be used to merge the data sets. Microfluidics could also be developed to automate this process.

Ultimately, the devices could be used to crystallize and obtain structures from G protein-coupled receptors. GPCRs are excellent candidates for the XOp and ShDi technologies as these proteins are poorly expressed in heterologous systems. The β₂-adrenergic receptor, several active mutants of rhodopsin, and other receptors including the muscarinic acetylcholine receptors and the CCR4 and CCR5 chemokine receptors could be provided, for example, from Dan Opria's lab at Brandeis.

### Figures

FIGS. 3A-3D. (A) The free energy of crystal formation AG as a function of crystal radius r. ΔGb and ΔGc correspond to high and low supersaturation, respectively. (B) Initially the protein solution stored in the well is a stable single phase and ΔG>0 for all r. (C) A chemical potential reservoir, located below the well, is filled with 6M NaCl causing the drop to greatly shrink as water osmotically flows out of the drop, raising supersaturation and creating a free energy, ΔGb, with a small nucleation barrier leading to production of many small crystals of minimum size r_{b}*. (D) Next, the reservoir is filled with 2M NaCl, causing the drop to slightly swell as water flows back into the drop, lowering supersaturation and raising the nucleation barrier, ΔGc. Only crystals larger than r_{c}* grow while smaller crystals melt. This transforms the small precipitates in (C) into a single large crystal, a process known as Ostwald ripening. Five times fewer crystals were observed when the protein drop in (B) was quenched directly to final condition (D), indicating the importance of controlling the kinetic pathway for protein crystallization. The protein solution was a mixture of 20 mg/ml lysozyme and 10% (w/w) poly(ethylene) glycol (PEG) of molecular weight 8000 g/mol dissolved in 0.2 M sodium acetate trihydrate and 0.1 M sodium cacodylate at pH 6.5 (See J. U. Shim, G. Cristobal, D. R. Link, T. Thorsen, Y. W. Jia, K. Piattelli, and S. Fraden. “Control and measurement of the phase behavior of aqueous solutions using microfluidics,” Journal of the American Chemical Society 129, 8825-35 (2007).)

FIGS. 4A-4B. Free Interface Diffusion (A) In this device (from Fluidigm) the protein solution is loaded into the top three cells while a salt solution is loaded into the bottom three cells. The valves between the salt and protein solutions are closed during filling. (B) Generic phase diagram for protein crystallization illustrating free interface diffusion, vapor diffusion, and microbatch. After opening the valves, salt rapidly diffuses into the protein side, while the protein diffuses into the salt side at a slower rate, a process known as Free Interface Diffusion. The average concentrations inside upper (lower) well III in FIG. 4A evolve in time along the upper (lower) curve III in FIG. 4B. Initially, the protein solution is stable, then as salt rapidly diffuses into the cell the solution moves deep into the metastable region where the nucleation rate is high, and as protein slowly diffuses out of the upper cell the solution finally reaches the equilibrium composition where crystal growth is slow. The vapor diffusion process follows the black arrow while for microbatch processes (the isolated dot) the average solution composition is fixed. Figure adapted from Hansen et al. (See J. M. Garcia-Ruiz, “Counterdiffusion methods for macromolecular crystallization,” in Methods in Enzymology, Vol. 368, p. 130 (2003).)

FIGS. 5A-5B. (A) Photograph of reservoir layer only of XOp chip. Colored dyes are used to visualize the gradient in concentration generated with two inlets. (B) Magnified view of the second and third reservoir of XOp chip. The square lattice is posts supporting the permeation membrane. Note that the protein drop over the 4M reservoir is turbid, indicative of a phase transition, while the drop over the 3.6M is clear.

FIGS. 6A-6C. (A) Schematic of XOp chip that generates gradients in temperature and concentration. (B) Concentration varies horizontally and temperature varies vertically. (C) Each drop has a different kinetic supersaturation profile. Blue (T₃) and green curves (T₂) correspond to drops along rows 3 and 2, respectively.

FIGS. 7A-7D. 50 micron diameter surfactant stabilized lysozyme droplets loaded in a single capillary and placed on the XOp temperature gradient stage. Crystals formed after several hours.

FIGS. 8A-8C. (A) XOp chip mounted on temperature gradient stage. Video images were acquired using a zoom microscope with reflection illumination. (B) Magnified image. Crystals are present on the left half of the image. (C) Further magnification of selected drops.

FIG. 9. Emulsion of lysozyme and salt incubated in a vial off-chip at crystallization conditions producing enhanced results. Average drop diameter was 100 microns.

FIGS. 10A-10B. (A) Lysozyme crystal-bearing drops in a thin-walled 200 micron diameter glass capillary, mounted for data collection at CHESS. The central circle was 100 microns across. (B) Diffraction pattern from the lysozyme crystal centered in (A), taken with a 100 micron collimated monochromatic beam at CHESS beam line F1.

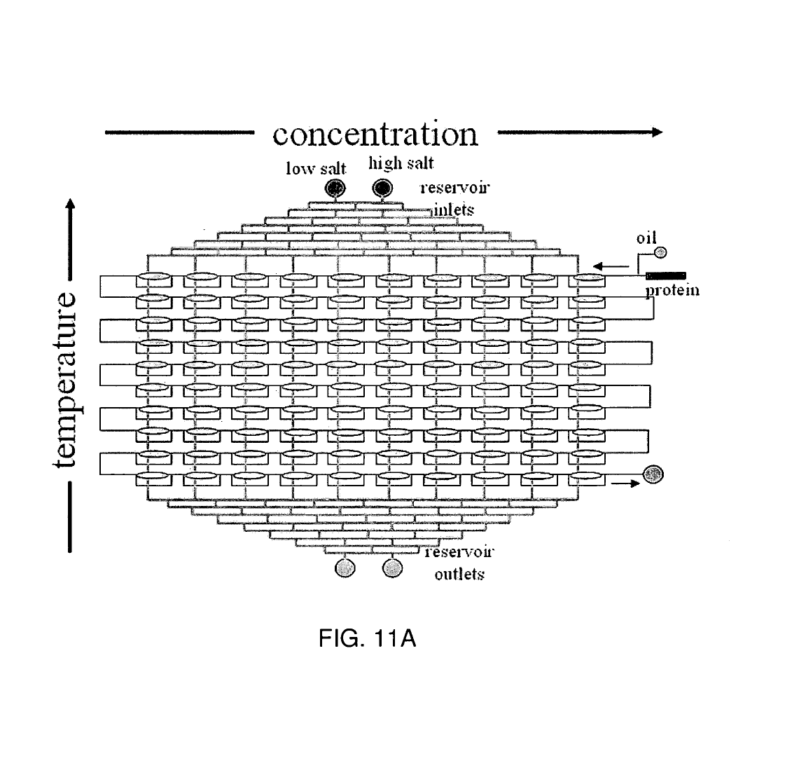

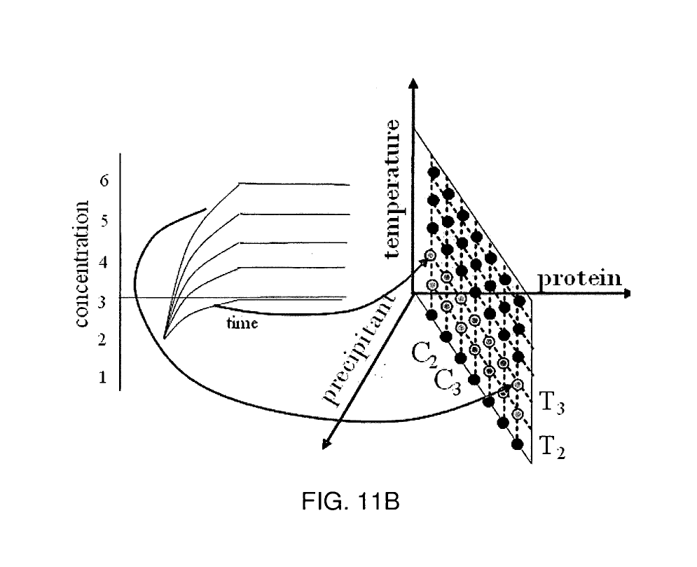

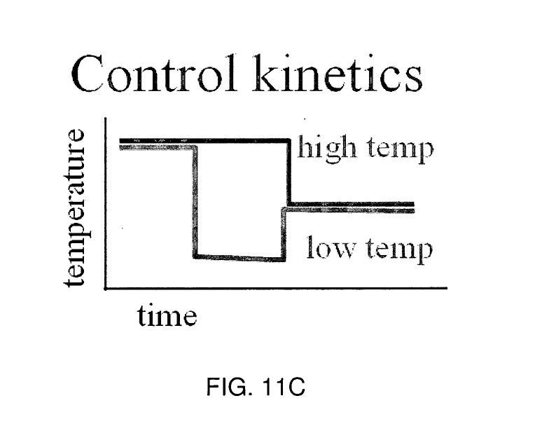

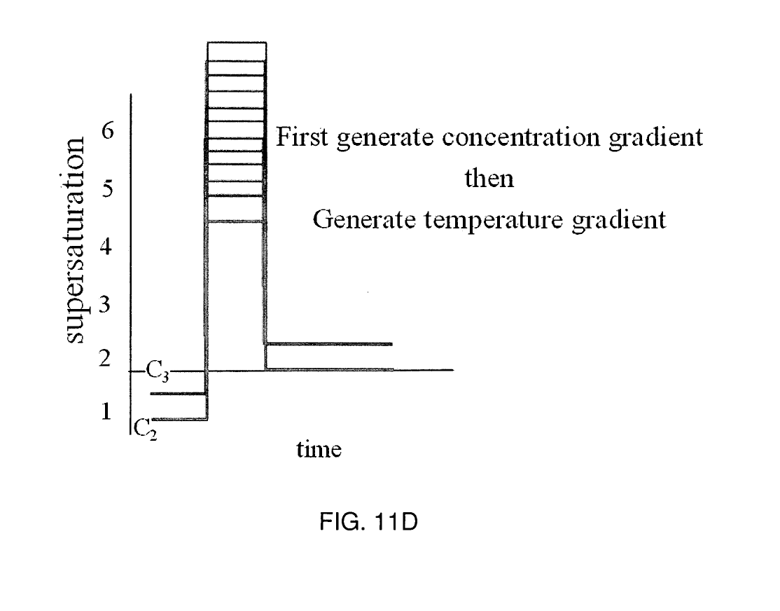

FIGS. 11A-11D. The XOp chip (A) Schematic of XOp chip that generates gradients in temperature and concentration. (B) Concentration varies horizontally and temperature varies vertically. First, the concentration gradient may be generated while temperature is held constant. (C) Then, a gradient in temperature may be applied across the chip for a duration of arbitrary length. (D) Each drop may be supersaturated to a different extent as schematically indicated for two initial concentrations.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A method, comprising:
establishing a gradient in at least one parameter across a plurality of confined volumes;
determining at least one property of an interaction in at least one confined volume;
based upon the property determining step, determining a relationship between at least one parameter and at least one property.

2. A method as in claim 1, wherein the parameter comprises temperature.

3. A method as in claim 1, wherein the interaction comprises crystallization.

4. A method as in claim 1, wherein the interaction comprises precipitation of an amorphous particle.

5. A method as in claim 1, wherein the interaction comprises a chemical reaction.

6. A method as in claim 1, wherein determining at least one property comprises determining whether a single crystal has formed within at least one confined volume.

7. A method as in claim 1, wherein determining at least one property comprises determining whether any crystals have formed within at least one confined volume.

8. A method as in claim 1, wherein determining at least one property comprises determining the rate of formation of a crystal within at least one confined volume.

9. A method as in claim 1, wherein determining at least one property comprises determining the crystallographic orientation of a crystal formed in at least one confined volume.

10. A method as in claim 1, wherein determining at least one property comprises determining the percent yield of at least one product within at least one confined volume.

11. A method as in claim 1, wherein determining at least one property comprises determining the concentration of a component within at least one confined volume.

12. A method as in claim 1, further comprising performing an additional interaction based at least in part upon the relationship between at least one parameter and at least one reaction property.

13. A method as in claim 12, wherein the additional interaction comprises crystallization.

14. A method as in claim 12, wherein the additional interaction comprises precipitation of an amorphous particle.

15. A method as in claim 12, wherein the additional interaction comprises a chemical reaction.

16. (canceled)

17. (canceled)

18. A method as in claim 1, wherein determining comprises performing X-ray diffraction.

19. A method as in claim 1, wherein determining comprises optical detection.

20. A method as in claim 1, wherein the first and second confined volumes are contained within a microfluidic channel.

21. A method as in claim 1, wherein the confined volume comprises a droplet.

22. A method as in claim 1, wherein the confined volume comprises a microwell.
